(19) United States
(12) Patent Application Publication
(10) Pub. No.: US 2005/0288407 A1
(43) Pub. Date: Dec. 29, 2005

(54) Thermally stabilized polycarbonate composition

(75) Inventors: Helmut-Werner Heuer, Krefeld (DE); Melanie Mothrath, Dusseldorf (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/157,092

(22) Filed: Jun. 20, 2005

(30) Foreign Application Priority Data
Jun. 24, 2004 (DE) 1020040306648
Nov. 27, 2004 (DE) 1020040573492

(51) Int. Cl. C08K 5/41

(52) U.S. Cl. 524/155

(57) ABSTRACT

A thermoplastic composition comprising polycarbonate characterized by its improved thermal stability is disclosed. The composition comprises at least one ester of organic sulfur-containing acids and may further contain the degradation products of such ester. The inventive composition is suitable for making molded articles and extrudates.

### FIELD OF THE INVENTION

This invention is directed to thermoplastic polycarbonate and in particular to thermally stable polycarbonate compositions.

### BACKGROUND OF THE INVENTION

The production processes for polycarbonate are known from the literature and described in many applications:

Regarding the production of polycarbonates by the interfacial polycondensation process or by the melt transesterification process, reference is made by way of example to “Schnell”, Chemistry and Physics of Polycarbonates, Polymer Reviews, Vol. 9, Interscience Publishers, New York, London, Sydney 1964, p. 33 ff. and to Polymer Reviews, Volume 10, “Condensation Polymers by Interfacial and Solution Methods”, Paul W. Morgan, Interscience Publishers, New York 1965, chapter VIII, p. 325, and to EP-A 971790.

When exposed to high temperatures, polycarbonates need stabilizers to prevent discoloration, chemical reactions of additives and degradation reactions. During subsequent processing, polycarbonates for optical applications in particular may be exposed to high temperatures, which lead to undesirable formation of monomers by degradation reactions, loss of molecular weight or to chemical reactions of additives, such as incorporation into the polymer chain, for example, and the degradation of additives, which have a negative influence on the effectiveness of the additives.

Stabilization against high temperatures with organophosphorus compounds such as phosphines (U.S. Pat. No. 4,092,288 B) or phosphites (JP 54036363 A) is known. Also known is stabilization with onium salts, such as tetraalkyl phosphonium and ammonium salts, dodecyl benzene sulfonic acid and with acids or a simple acid ester of an acid containing a sulfur atom, such as n-butyl tosylate (JP 08-059975 A).

Organophosphorus heat stabilizers are conventionally added to the polycarbonate in amounts of the order of several 100 ppm. In the case of polycarbonate grades for optical applications in particular, however, the aim is to use only the very minimum amounts of additives. The purpose of this is to suppress undesirable effects of particle formation or casting problems in injection molding and to ensure a positive overall performance of the material.

For economic reasons too, only extremely small amounts of additives are desirable.

In the case of the free acids and readily cleaving esters described, their corrosive properties at high temperatures and concentrations, such as may occur for example in industrial metering of stabilizers, has proved to be disadvantageous. It is very advantageous to use stabilizers which do not compromise the materials from which the equipment is made, to prevent particles, metallic cations and safety defects. A majority of the free acids and readily cleaving esters described are also highly volatile. This makes it harder to achieve the necessary constant and clean metering of quenchers with continuous incorporation into the melt stream.

A further disadvantage of many acid ester stabilizers is that they generate large amounts of free acids too quickly. An excess of free acid catalyses reactions of polycarbonates with other additives such as release agents, for example, or in the case of the melt polycarbonate even promotes reverse reactions with phenol, releasing diphenyl carbonate. On the other hand, small amounts of excess ester-bound acid, which release the free acid very slowly on exposure to heat when the stabilised polycarbonate undergoes further processing, are highly desirable. They increase the thermal stability of the polycarbonate.

The object was therefore to find heat stabilizers for polycarbonate which need to be added in only small quantities, are non-corrosive and have low volatility and at the same time are readily soluble and may be added in inert solvents or in components that are integral to the process. Furthermore, the stabilizers should never generate large excesses of free acid in the polycarbonate, in order to prevent degradation reactions of polycarbonate with formation of carbonates and also to suppress reactions with the additives. Instead of this, a slow generation of the free acids is desired. This is particularly desirable if the stabilizer does not completely form all possible free acid during incorporation into the polycarbonate and any subsequent steps. It may therefore continue to have an effect during subsequent processing after pelletizing of the polycarbonate, such as injection molding for example (long-term effect through successive release of the free acid during all steps involving exposure to heat).

### SUMMARY OF THE INVENTION

A thermoplastic composition comprising polycarbonate characterized by its improved thermal stability is disclosed. The composition comprises at least one ester of organic sulfur-containing acids and may further contain the degradation products of such ester. The inventive composition is suitable for making molded articles and extrudates.

### DETAILED DESCRIPTION OF THE INVENTION

Surprisingly it was found that esters of organic sulfur-containing acids combine the desired properties in a balanced way and are extremely suitable for the thermal stabilization of polycarbonates. For example, these stabilizers surprisingly release the corresponding free acids only slowly and in stages. Furthermore, they have such low inherent volatility that even with extended residence times they scarcely evaporate out of the polycarbonate melt.

Even at high temperatures and concentrations, the stabilizers surprisingly display no corrosive behaviour towards the metal materials that are conventionally used, such as e.g. 1.4571 or 1.4541 (Stahlschlüssel 2001, published by Stahlschlüssel Wegst GmbH, Th-Heuss-Straβe 36, D-71672 Marbach) and Ni-based alloys of type C, such as e.g. 2.4605 or 2.4610 (Stahlschlüssel 2001, published by Stahlschlüssel Wegst GmbH, Th-Heuss-Straβe 36, D-71672 Marbach).

This is particularly astonishing since during the stabilization of polycarbonate it is generally impossible to forecast whether the stabilizers combine to the correct extent the desired properties such as low volatility, solubility in solvents inherently used in the process, freedom from corrosion and slow acid release.

This invention therefore provides compositions having improved thermal stability and containing polycarbonate and esters of organic sulfur-containing acids, together with molded articles and extrudates produced from these modified polycarbonate compositions, wherein the compositions may also additionally contain degradation products of these esters.

Preferred heat stabilizer suitable according to the invention is at least one ester of organic sulfur-containing acid, conforming to a formula selected from the group consisting of
a) formula (I) 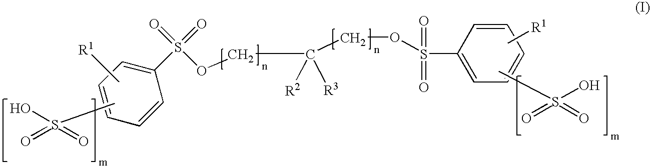
wherein
R¹ independently stands for hydrogen or for C₁-C₂₀ alkyl, preferably for C₁-C₈ alkyl, particularly preferably for unsubstituted C₁-C₆ alkyl, most particularly preferably for C₁-C₄ alkyl, wherein the alkyl may be substituted by halogen, in particular by hydrogen or methyl,
R² and R³ mutually independently stand for hydrogen, or for C₁-C₆ alkyl, C₄-C₃₀ alkyl carboxyl, preferably C₁-C₄ alkyl, C₆-C₂₅ alkyl carboxyl, particularly preferably for C₈-C₂₀ alkyl carboxyl, in particular for hydrogen, C₁₇ alkyl carboxyl or C₁₅ alkyl carboxyl, or
   for the radical 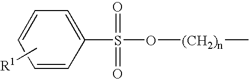
   wherein
   R¹ has the meaning given above,
   m mutually independently stands for 0 or 1,
   n stands for a whole number from 0 to 8, preferably 0 to 6, in particular 0, 1 or 2,
   b) formula (II) 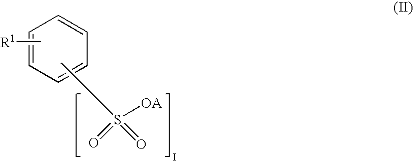
   wherein
   R¹ has the meaning given above,
A independently stands for hydrogen or for C₁-C₁₂ alkyl, preferably for C₁-C₈ alkyl, particularly preferably for ethyl, propyl or butyl,
   l stands for 2 or 3,
c) formula (III) 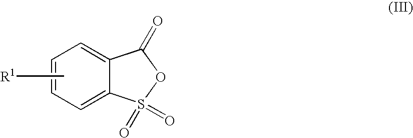
   wherein
   R¹ has the meaning given above and
d) formula (IV) 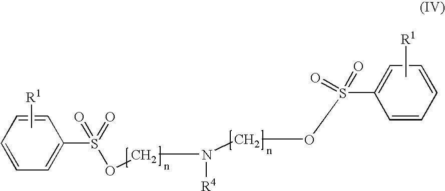
   wherein
   R¹ and n have the meaning given above, and
   R⁴ stands for C₄-C₃₀ alkyl carboxyl, preferably C₆-C₂₅ alkyl carboxyl, particularly preferably for C₈-C₂₀ alkyl carboxyl, in particular for C₁₇ alkyl carboxyl or C₁₅ alkyl carboxyl or
      for the following radical 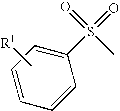
      wherein R¹ has the meaning given above, and
   e) formulas (V), (VI), (VIIa), (VIIb), (Ib), (IVa) 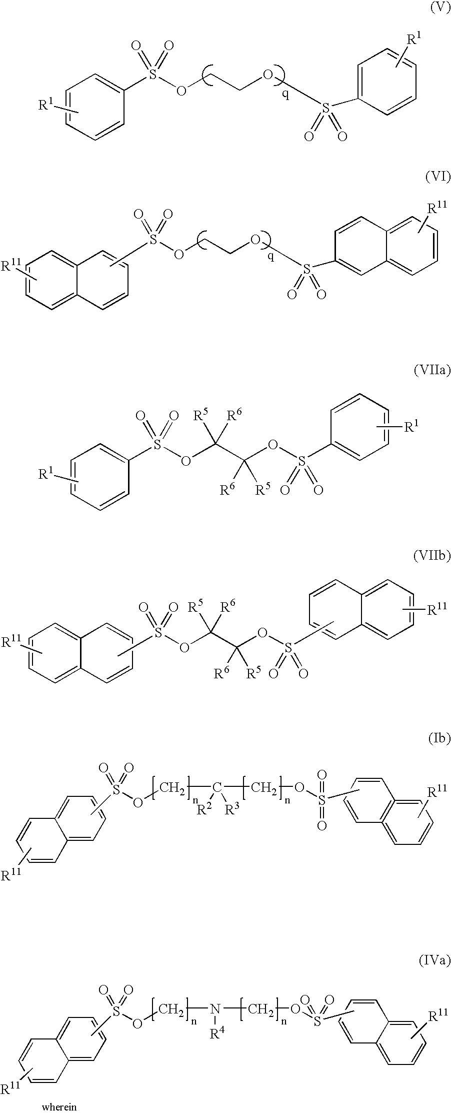
   R¹ and n have the meaning given above, and
   q stands for a whole number from 0 to 10, preferably 1 to 8, in particular 1 to 5, and
   R⁵ and R⁶ independently stand for hydrogen or for C₁-C₂₀ alkyl, preferably for C₁-C₈ alkyl, particularly preferably for C₁-C₆ alkyl, most particularly preferably for C₁-C₄ alkyl, wherein alkyl may be substituted by halogen, in particular for hydrogen or methyl, and
   R¹¹ independently stands for hydrogen or di-(C₁-C₄) alkyl amino, preferably for hydrogen or dimethyl amino, and
f) formula (VIII) 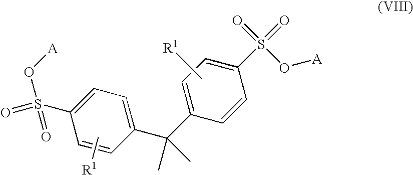
   wherein
   R¹ and A have the meaning given above and
g) formula (IX) 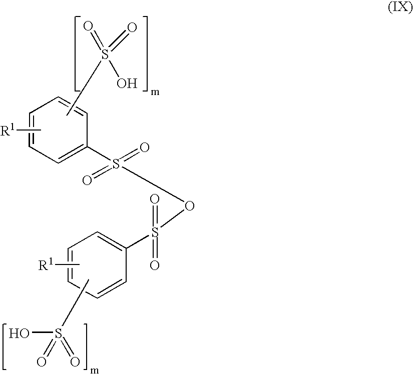
   wherein
   R¹ and m have the meaning given above and
h) formula (X) 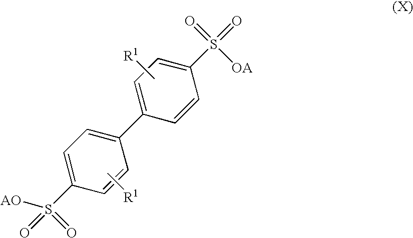
   wherein
   R¹ and A have the meaning given above and
i) formula (XI) 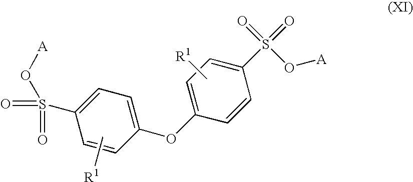
   wherein
   R¹ and A have the meaning given above.

Most particularly preferred are the heat stabilizers conforming to formulae (Ia) to (If), (IIIa), (IVb), (Va), (Vb) and (IXa):

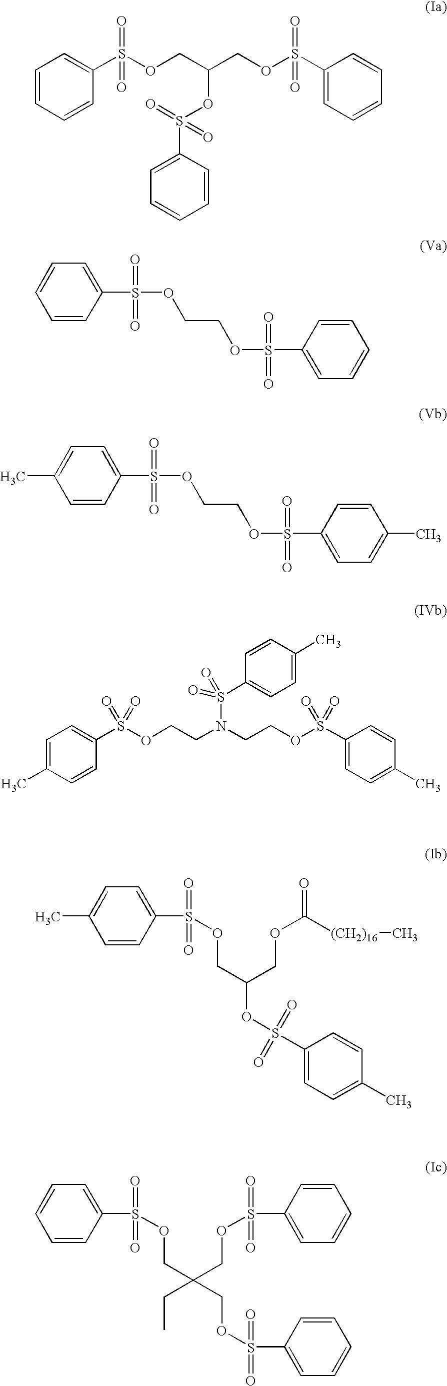

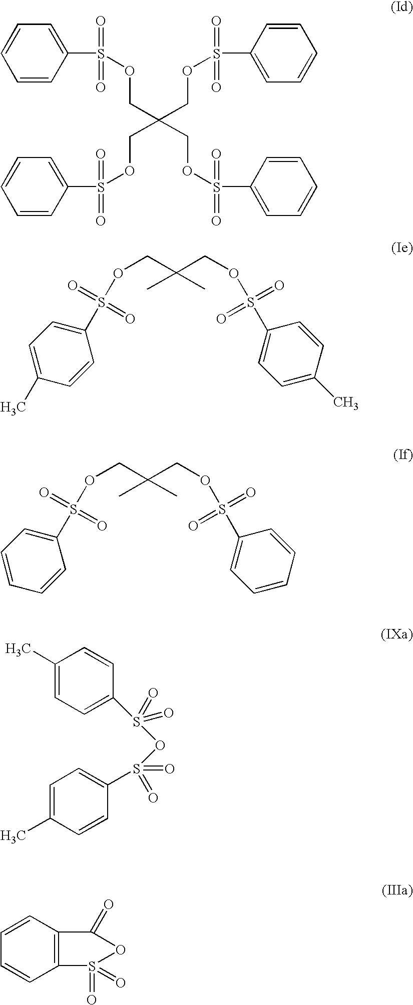

The heat stabilizers according to the invention may be added to the polymer melt alone or in any mixture or in several different mixtures. The heat stabilizers according to the invention may also be added in mixtures with free acids, such as ortho-phosphoric acid for example.

The esters of organic sulfur-containing acids according to the invention are produced by conventional methods, for example by alcoholysis from benzene sulfonic acid chloride or toluene sulfonic acid chloride with the corresponding polyhydric alcohols (cf. Organikum, Wiley-VCH Verlag, 20th Edition, Weinheim, p. 606/1999).

The polycarbonate may be produced by the melt transesterification process, or by the interfacial polycondensation process, for example. The production of aromatic oligocarbonates or polycarbonates by the melt transesterification process is known from the literature and is described for example in the Encyclopedia of Polymer Science, Vol. 10 (1969), Chemistry and Physics of Polycarbonates, Polymer Reviews, H. Schnell, Vol. 9, John Wiley and Sons, Inc. (1964) and in DE-C 10 31 512, U.S. Pat. No. 3,022,272, U.S. Pat. No. 5,340,905 and U.S. Pat. No. 5,399,659.

According to this process, aromatic dihydroxy compounds are transesterified in the melt with carbonic acid diesters, with the aid of suitable catalysts and optionally other additives.

A plant design as shown in WO 02/077 067, for example, may be used to perform the process.

Suitable dihydroxyaryl compounds for the production of polycarbonates are those having the formula (XII)
HO-Z-OH (XII)
wherein Z is an aromatic radical having 6 to 30 C atoms, which may contain one or more aromatic nuclei, may be substituted, and may contain aliphatic or cycloaliphatic radicals or alkyl aryls or heteroatoms as binding links.

Examples of dihydroxyaryl compounds are: dihydroxybenzenes, dihydroxydiphenyls, bis(hydroxyphenyl) alkanes, bis(hydroxyphenyl) cycloalkanes, bis(hydroxyphenyl) aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl) diisopropyl benzenes, and ring-alkylated and ring-halogenated compounds thereof.

These and further suitable other dihydroxyaryl compounds are described for example in U.S. Pat. Nos. 2,970,131, 2,991,273, 2,999,835, 2,999,846, 3,028,365, 3,062,781, 3,148,172, 3,271,367, 3,275,601, 4,982,014, in German patent specifications 1 570 703, 2 063 050, 2 036 052, 2 211 956, 3 832 396, French patent specification 1 561 518, and in the monograph “H. Schnell, Chemistry and Physics of Polycarbonates, Interscience Publishers, New York 1964, p. 28 ff; p. 102 ff”, and in “D. G. Legrand, J. T. Bendler, Handbook of Polycarbonate Science and Technology, Marcel Dekker, New York 2000, p. 72 ff”.

Preferred dihydroxyaryl compounds are, for example: resorcinol, 4,4′-dihydroxydiphenyl, bis-(4-hydroxyphenyl) methane, bis-(3,5-dimethyl-4-hydroxyphenyl) methane, bis-(4-hydroxyphenyl) diphenyl methane, 1,1-bis-(4-hydroxyphenyl)-1-phenyl ethane, 1,1-bis-(4-hydroxyphenyl)-1-(1-naphthyl) ethane, 1,1-bis-(4-hydroxyphenyl)-1-(2-naphthyl) ethane, 2,2-bis-(4-hydroxyphenyl) propane, 2,2-bis-(3-methyl-4-hydroxyphenyl) propane, 2,2-bis-(3,5-dimethyl-4-hydroxyphenyl) propane, 2,2-bis-(4-hydroxyphenyl)-1-phenyl propane, 2,2-bis-(4-hydroxyphenyl) hexafluoropropane, 2,4-bis-(4-hydroxyphenyl)-2-methyl butane, 2,4-bis-(3,5-dimethyl-4-hydroxyphenyl)-2-methyl butane, 1,1-bis-(4-hydroxyphenyl) cyclohexane, 1,1-bis-(3,5-dimethyl-4-hydroxyphenyl) cyclohexane, 1,1-bis-(4-hydroxyphenyl)-4-methyl cyclohexane, 1,1-bis-(4-hydroxyphenyl)-3,3,5-trimethyl cyclohexane, 1,3-bis-[2-(4-hydroxyphenyl)-2-propyl] benzene, 1,1′-bis-(4-hydroxyphenyl)-3-diisopropyl benzene, 1,1′-bis-(4-hydroxyphenyl)-4-diisopropyl benzene, 1,3-bis-[2-(3,5-dimethyl-4-hydroxyphenyl)-2-propyl] benzene, bis-(4-hydroxyphenyl) ether, bis-(4-hydroxyphenyl) sulfide, bis-(4-hydroxyphenyl) sulfone, bis-(3,5-dimethyl-4hydroxyphenyl) sulfone and 2,2′,3,3′-tetrahydro-3,3,3′,3′-tetramethyl-1,1′-spirobi-[1H-indene]-5,5′-diol.

Particularly preferred dihydroxyaryl compounds are: resorcinol, 4,4′-dihydroxydiphenyl, bis-(4-hydroxyphenyl) diphenyl methane, 1,1-bis-(4-hydroxyphenyl)-1-phenyl ethane, bis-(4-hydroxyphenyl)-1-(1-naphthyl) ethane, bis-(4-hydroxyphenyl)-1-(2-naphthyl) ethane, 2,2-bis-(4-hydroxyphenyl) propane, 2,2-bis-(3,5-dimethyl-4-hydroxyphenyl) propane, 1,1-bis-(4-hydroxyphenyl) cyclohexane, 1,1-bis-(3,5-dimethyl-4-hydroxyphenyl) cyclohexane, 1,1-bis-(4-hydroxyphenyl)-3,3,5-trimethylcyclohexane, 1,1′-bis-(4-hydroxyphenyl)-3-diisopropyl benzene and 1,1′-bis-(4-hydroxyphenyl)-4-diisopropyl benzene.

Most particularly preferred are: 4,4′-dihydroxydiphenyl, 2,2-bis-(4-hydroxyphenyl) propane and bis-(4-hydroxyphenyl)-3,3,5-trimethylcyclohexane.

Both one dihydroxyaryl compound, forming homopolycarbonates, and several dihydroxyaryl compounds, forming copolycarbonates, may be used.

Instead of the monomeric dihydroxyaryl compounds, low-molecular-weight, predominantly OH end group terminated oligocarbonates may also be used as starting compound.

The dihydroxyaryl compounds may also be used with residual contents of the monohydroxyaryl compounds from which they were produced, or the low-molecular-weight oligocarbonates may also be used with residual contents of the monohydroxyaryl compounds which were eliminated during production of the oligomers. The residual contents of the monomeric hydroxyaryl compounds may be up to 20%, preferably 10%, particularly preferably up to 5% and most particularly preferably up to 2% (see e.g. EP-A 1 240 232).

The dihydroxyaryl compounds that are used, like all other raw materials, chemicals and auxiliary substances added to the synthesis, may be contaminated with impurities originating from their own synthesis, handling and storage, although it is desirable and the aim is to work with raw materials, chemicals and auxiliary substances that are as clean as possible.

The diaryl carbonates that are suitable for reacting with the dihydroxyaryl compounds are those having the formula (XIII) 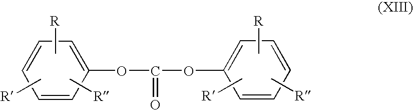
wherein R, R′ and R″ are the same or different and mutually independently stand for hydrogen, optionally branched C₁-C₃₄ alkyl, C₇-C₃₄ alkyl aryl or C₆-C₃₄ aryl, R may also denote —COO—R′″, wherein R′″ stands for hydrogen, optionally branched C₁-C₃₄ alkyl, C₇-C₃₄ alkyl aryl or C₆-C₃₄ aryl.

Such diaryl carbonates are, for example: diphenyl carbonate, methylphenyl phenyl carbonates and di(methylphenyl) carbonates, 4-ethylphenyl phenyl carbonate, di-(4-ethylphenyl) carbonate, 4-n-propylphenyl phenyl carbonate, di-(4-n-propylphenyl) carbonate, 4-isopropylphenyl phenyl carbonate, di-(4-isopropylphenyl) carbonate, 4-n-butylphenyl phenyl carbonate, di-(4-n-butylphenyl) carbonate, 4-isobutylphenyl phenyl carbonate, di-(4-isobutylphenyl) carbonate, 4-tert-butylphenyl phenyl carbonate, di-(4-tert-butylphenyl) carbonate, 4-n-pentylphenyl phenyl carbonate, di-(4-n-pentylphenyl) carbonate, 4-n-hexylphenyl phenyl carbonate, di-(4-n-hexylphenyl) carbonate, 4-isooctylphenyl phenyl carbonate, di-(4-isooctylphenyl) carbonate, 4-n-nonylphenyl phenyl carbonate, di-(4-n-nonylphenyl) carbonate, 4-cyclohexylphenyl phenyl carbonate, di-(4-cyclohexylphenyl) carbonate, 4-(1-methyl-1-phenylethyl)phenyl phenyl carbonate, di-[4-(1-methyl-1-phenylethyl)phenyl] carbonate, biphenyl-4-ylphenyl carbonate, di(biphenyl-4-yl) carbonate, 4-(1-naphthyl)phenyl phenyl carbonate, 4-(2-naphthyl)phenyl phenyl carbonate, di-[4-(1-naphthyl)phenyl] carbonate, di-[4-(2-naphthyl)phenyl] carbonate, 4-phenoxyphenyl phenyl carbonate, di-(4-phenoxyphenyl) carbonate, 3-pentadecylphenyl phenyl carbonate, di-(3-pentadecylphenyl) carbonate, 4-tritylphenyl phenyl carbonate, di-(4-tritylphenyl) carbonate, methyl salicylate phenyl carbonate, di(methyl salicylate) carbonate, ethyl salicylate phenyl carbonate, di(ethyl salicylate) carbonate, n-propyl salicylate phenyl carbonate, di-(n-propyl salicylate) carbonate, isopropyl salicylate phenyl carbonate, di(isopropyl salicylate) carbonate, n-butyl salicylate phenyl carbonate, di-(n-butyl salicylate) carbonate, isobutyl salicylate phenyl carbonate, di(isobutyl salicylate) carbonate, tert-butyl salicylate phenyl carbonate, di-(tert-butyl salicylate) carbonate, di(phenyl salicylate) carbonate and di(benzyl salicylate) carbonate.

Preferred diaryl compounds are: diphenyl carbonate, 4-tert-butylphenyl phenyl carbonate, di-(4-tert-butylphenyl) carbonate, biphenyl-4-ylphenyl carbonate, di(biphenyl-4-yl) carbonate, 4-(1-methyl-1-phenylethyl)phenyl phenyl carbonate and di-[4-(1-methyl-1-phenylethyl)phenyl] carbonate.

Particularly preferred is: diphenyl carbonate.

The diaryl carbonates may also be used with residual contents of the monohydroxyaryl compounds from which they were produced. The residual contents of monohydroxyaryl compounds may be up to 20%, preferably 10%, particularly preferably up to 5% and most particularly preferably up to 2%.

Relative to the dihydroxyaryl compound the diaryl carbonates are generally used in a quantity of 1.02 to 1.30 mol, preferably 1.04 to 1.25 mol, particularly preferably 1.06 to 1.22 mol, most particularly preferably 1.06 to 1.20 mol per mol of dihydroxyaryl compound. Mixtures of the aforementioned diaryl carbonates may also be used.

A monohydroxyaryl compound that was not used to produce the diaryl carbonate being used may additionally be used to control or modify the end groups. It is represented by the following general formula (XIV): 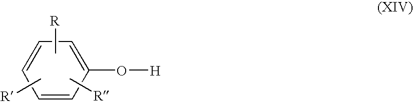
wherein R, R′ and R″ have the meaning given for formula (XIII) with the proviso that in this case R cannot be H, but R′ and R″ may be H.

Such monohydroxyaryl compounds are, for example: 1-, 2- or 3-methylphenol, 2,4-dimethylphenol, 4-ethylphenol, 4-n-propylphenol, 4-isopropylphenol, 4-n-butylphenol, 4-isobutylphenol, 4-tert-butylphenol, 4-n-pentylphenol, 4-n-hexylphenol, 4-isooctylphenol, 4-n-nonylphenol, 3-pentadecylphenol, 4-cyclohexylphenol, 4-(1-methyl-1-phenylethyl)phenol, 4-phenylphenol, 4-phenoxyphenol, 4-(1-naphthyl)phenol, 4-(2-naphthyl)phenol, 4-tritylphenol, methyl salicylate, ethyl salicylate, n-propyl salicylate, isopropyl salicylate, n-butyl salicylate, isobutyl salicylate, tert-butyl salicylate, phenyl salicylate and benzyl salicylate.

4-tert-Butylphenol, 4-isooctylphenol and 3-pentadecylphenol are preferred.

A monohydroxyaryl compound should be chosen whose boiling point is above that of the monohydroxyaryl compound that was used to produce the diaryl carbonate being used. The monohydroxyaryl compound may be added at any time in the course of the reaction. It is preferably added at the start of the reaction or at any point in the course of the process. The proportion of free monohydroxyaryl compound may be 0.2 to 20 mol %, preferably 0.4 to 10 mol %, relative to the dihydroxyaryl compound.

The end groups may also be modified by the incorporation of a diaryl carbonate whose base monohydroxyaryl compound has a higher boiling point than the base monohydroxyaryl compound in the principal diaryl carbonate that is used. Here too the diaryl carbonate may be added at any time in the course of the reaction. It is preferably added at the start of the reaction or at any point in the course of the process. The proportion of the diaryl carbonate with the higher-boiling base monohydroxyaryl compound relative to the total amount of diaryl carbonate used may be 1 to 40 mol %, preferably 1 to 20 mol % and particularly preferably 1 to 10 mol %.

The basic catalysts known from the literature such as e.g. alkali and alkaline-earth hydroxides and oxides, but also ammonium or phosphonium salts, referred to below as onium salts, are used as catalysts in the melt transesterification process for the production of polycarbonates. Onium salts are preferably used in the synthesis, particularly preferably phosphonium salts. Phosphonium salts within the meaning of the invention are those having the general formula (XV): 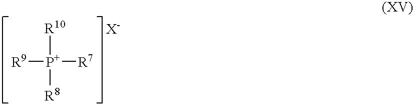
wherein R⁷⁻¹⁰ may be the same or different C₁-C₁₀ alkyls, C₆-C₁₄ aryls, C₇-C₁₅ aryl alkyls or C₅-C₆ cycloalkyls, preferably methyl or C₆-C₁₄ aryls, particularly preferably methyl or phenyl, and X⁻ may be an anion such as hydroxide, sulfate, hydrogen sulfate, hydrogen carbonate, carbonate or a halide, preferably chloride or an alkylate or arylate having the formula —OR, wherein R may be a C₆-C₁₄ aryl, C₇-C₁₅ aryl alkyl or C₅-C₆ cycloalkyl, preferably phenyl.

Preferred catalysts are tetraphenyl phosphonium chloride, tetraphenyl phosphonium hydroxide and tetraphenyl phosphonium phenolate, with tetraphenyl phosphonium phenolate being particularly preferred.

They are preferably used in quantities of 10⁻⁸ to 10⁻³ mol, relative to one mol of dihydroxyaryl compound, particularly preferably in quantities of 10⁻⁷ to 10⁻⁴ mol.

Other catalysts may be used alone or in addition to the onium salt as co-catalyst to increase the speed of polycondensation.

They include the alkaline salts of alkali metals and alkaline-earth metals, such as hydroxides, alkoxides and aryloxides of lithium, sodium and potassium, preferably hydroxides, alkoxides or aryloxides of sodium. Most preferred are sodium hydroxide and sodium phenolate, along with the disodium salt of 2,2-bis-(4-hydroxyphenyl) propane.

The amounts of alkaline salts of alkali metals and alkaline-earth metals alone or as co-catalyst may range from 1 to 500 ppb, preferably 5 to 300 ppb and most preferably 5 to 200 ppb, calculated as sodium in each case and relative to polycarbonate to be formed.

The alkaline salts of alkali metals and alkaline-earth metals may be used during production of the oligocarbonates, i.e. at the start of synthesis, or may be added just before polycondensation, to suppress undesirable secondary reactions.

It is also possible to add supplementary amounts of onium catalysts of the same or of a different type before polycondensation.

The catalysts are added in solution to avoid harmful excess concentrations during metering. The solvents are compounds inherent to the system and to the process, such as e.g. dihydroxyaryl compounds, diaryl carbonates or monohydroxyaryl compounds. Monohydroxyaryl compounds are particularly preferred, because the person skilled in the art is aware that dihydroxyaryl compounds and diaryl carbonates readily change and break down even at slightly elevated temperatures, especially under the influence of catalysts. This affects the quality of the polycarbonates. In the industrial transesterification process for the production of polycarbonate the preferred compound is phenol. Phenol is therefore also the logical choice because the preferably used catalyst tetraphenyl phosphonium phenolate when produced as a mixed crystal is isolated with phenol.

The thermoplastic polycarbonates are described by the formula (XVI) 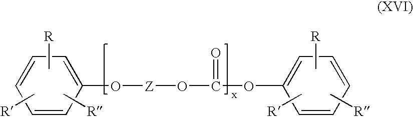
wherein
R, R′ and R″ and Z have the meaning given for formula (XIII) and (XII),
x is a repeating structural unit, its magnitude determines the molecular weight of the polycarbonate.

The radical 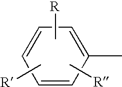
may also be H as an entire group in formula (XVI) and may be different on each side.

The weight-average molecular weights obtained for the polycarbonates are generally 15,000 to 40,000, preferably 17,000 to 36,000, particularly preferably 17,000 to 34,000, wherein the weight-average molecular weight was determined by the relative viscosity according to the Mark-Houwing correlation (J. M. G. Cowie, Chemie und Physik der synthetischen Polymeren, Vieweg Lehrbuch, Braunschweig/Wiesbaden, 1997, page 235).

The polycarbonates have an extremely low content of cations and anions of less than 60 ppb in each case, preferably <40 ppb and particularly preferably <20 ppb (calculated as Na cation), cations of both alkali and alkaline-earth metals being present, which may originate for example as an impurity from the raw materials that are used and from the phosphonium and ammonium salts. Other ions such as Fe, Ni, Cr, Zn, Sn, Mo, Al ions and homologues thereof may be contained in the raw materials or may originate through erosion or corrosion from the materials from which the plant used is constructed. The total content of these ions is less than 2 ppm, preferably less than 1 ppm and particularly preferably less than 0.5 ppm.

Anions of inorganic acids and organic acids are present in equivalent amounts (e.g. chloride, sulfate, carbonate, phosphate, phosphite, oxalate, etc.).

The aim is therefore to obtain the smallest possible amounts, which may only be achieved by using raw materials of the highest purity. Such pure raw materials may only be obtained by means of purification processes, for example, such as recrystallisation, distillation, reprecipitation with washing, etc.

The polycarbonates may be intentionally branched. Suitable branching agents are the compounds known for polycarbonate production having three or more functional groups, preferably those having three or more hydroxyl groups.

Examples of some of the compounds having three or more phenolic hydroxyl groups that may be used are: phloroglucinol, 4,6-dimethyl-2,4,6-tri-(4-hydroxyphenyl) heptene-2,4,6-dimethyl-2,4,6-tri-(4-hydroxyphenyl) heptane, 1,3,5-tri-(4-hydroxyphenyl) benzene, 1,1,1-tri-(4-hydroxyphenyl) ethane, tri-(4-hydroxyphenyl) phenyl methane, 2,2-bis-(4,4-bis-(4-hydroxyphenyl) cyclohexyl] propane, 2,4-bis-(4-hydroxyphenyl isopropyl) phenol and tetra-(4-hydroxyphenyl) methane.

Some of the other trifunctional compounds are: 2,4-dihydroxybenzoic acid, trimesic acid, cyanuric chloride and 3,3-bis-(3-methyl-4-hydroxyphenyl)-2-oxo-2,3-dihydroindole.

Preferred branching agents are: 3,3-bis-(3-methyl-4-hydroxyphenyl)-2-oxo-2,3-dihydroindole and 1,1,1-tri-(4-hydroxyphenyl) ethane.

The branching agents are generally used in quantities of 0.02 to 3.6 mol %, relative to the dihydroxyaryl compound.

The process for the production of polycarbonate by the transesterification process may be performed continuously or batchwise. Once the dihydroxyaryl compounds and diaryl carbonates, optionally with other compounds, are in melt form, the reaction is started in the presence of suitable catalysts. As temperatures rise and pressures fall, the conversion or the molecular weight is increased in suitable equipment and devices by drawing off the monohydroxyaryl compound that is eliminated, until the desired final state is achieved. The type and concentration of the end groups is influenced by the choice of the ratio of dihydroxyaryl compound to diaryl carbonate, of the rate of loss of diaryl carbonate via the vapours, which is determined by the choice of processing mode or plant for production of the polycarbonate, and of optionally added compounds such as a higher-boiling monohydroxyaryl compound, for example.

There are no limits or restrictions on the type and nature of the process, on the plant in which and mode by which it is performed.

In addition, there are no special limits or restrictions on the temperatures, the pressures and the catalysts used to perform the melt transesterification reaction between the dihydroxyaryl compound and the diaryl carbonate and any other reactants that are optionally added. Any condition is possible, provided that the chosen temperatures, pressures and catalysts allow melt transesterification to be performed with correspondingly rapid removal of the monohydroxyaryl compound that is eliminated.

The temperatures over the entire process are generally between 180 and 330° C., the pressures between 15 bar, absolute, and 0.01 mbar, absolute.

A continuous processing mode is usually chosen because it is advantageous for product quality.

The continuous process for the production of polycarbonates is preferably characterised in that one or more dihydroxyaryl compounds with the diaryl carbonate, optionally also other added reactants using catalysts, after precondensation without separation of the monohydroxyaryl compound that is formed, the molecular weight is increased to the desired level in several subsequent reaction-evaporator stages with gradually increasing temperatures and gradually reducing pressures.

Corresponding to the course of the process, the devices, equipment and reactors that are suitable for the individual reaction-evaporator stages are heat exchangers, decompression units, separators, columns, evaporators, stirred vessels and reactors or other commercial equipment which provides the necessary residence time at selected temperatures and pressures. The chosen devices must permit the necessary heat input and be constructed in such a way that they may cope with the continuously increasing melt viscosities.

All devices are connected to one another by means of pumps, pipes and valves. The pipes between all units should naturally be as short as possible, and the curvature of the pipes kept as low as possible, to avoid unnecessarily extended residence times. The external, i.e. technical, boundary conditions and requirements for the assembly of chemical plants must be observed.

To perform the process by a preferred continuous processing mode, the reaction partners may either be melted together or the solid dihydroxyaryl compound may be dissolved in the diaryl carbonate melt or the solid diaryl carbonate dissolved in the melt of the dihydroxyaryl compound, or both raw materials are combined as a melt, preferably directly from production. The residence times of the separate melts of the raw materials, in particular those of the melt of the dihydroxyaryl compound, are made as short as possible. The mixture of melts on the other hand, because of the lower melting point of the mixture of raw materials in comparison to the individual raw materials, may reside for longer at correspondingly lower temperatures with no loss of quality.

Then the catalyst is dissolved, preferably in phenol, incorporated and the melt heated to the reaction temperature. At the start of the industrial process for the production of polycarbonate from 2,2-bis-(4-hydroxyphenyl) propane and diphenyl carbonate this is 180 to 220° C., preferably 190 to 210° C., most particularly preferably 190° C. With residence times of 15 to 90 min, preferably 30 to 60 min, the reaction equilibrium is established without the hydroxyaryl compound that is formed being removed. The reaction may be performed under atmospheric pressure or also for technical reasons under excess pressure. The preferred pressure in industrial plants is 2 to 15 bar absolute.

The mixture of melts is decompressed in a first vacuum chamber whose pressure is set to 100 to 400 mbar, preferably 150 to 300 mbar, and immediately afterwards heated to the inlet temperature again in a suitable device under the same pressure. In the decompression process the hydroxyaryl compound that is formed is evaporated with monomers that are still present. After a residence time of 5 to 30 min in a settling tank, optionally with forced circulation, under the same pressure and at the same temperature, the reaction mixture is decompressed in a second vacuum chamber whose pressure is 50 to 200 mbar, preferably 80 to 150 mbar, and immediately afterwards heated to a temperature of 190 to 250° C., preferably 210 to 240° C., particularly preferably 210 to 230° C., in a suitable device under the same pressure. Here too the hydroxyaryl compound that is formed is evaporated with monomers that are still present. After a residence time of 5 to 30 min in a settling tank, optionally with forced circulation, under the same pressure and at the same temperature, the reaction mixture is decompressed in a third vacuum chamber whose pressure is 30 to 150 mbar, preferably 50 to 120 mbar, and immediately afterwards heated to a temperature of 220 to 280° C., preferably 240 to 270° C., particularly preferably 240 to 260° C., in a suitable device under the same pressure. Here too the hydroxyaryl compound that is formed is evaporated with monomers that are still present. After a residence time of 5 to 20 min in a settling tank, optionally with forced circulation, under the same pressure and at the same temperature, the reaction mixture is decompressed in a further vacuum chamber whose pressure is 5 to 100 mbar, preferably 15 to 100 mbar, particularly preferably 20 to 80 mbar, and immediately afterwards heated to a temperature of 250 to 300° C., preferably 260 to 290° C., particularly preferably 260 to 280° C., in a suitable device under the same pressure. Here too the hydroxyaryl compound that is formed is evaporated with monomers that are still present.

The number of these stages, 4 in this case by way of example, may vary between 2 and 6. If the number of stages is changed, the temperatures and pressures should be adjusted accordingly to give comparable results. The relative viscosity of the oligomeric carbonate reached in these stages is between 1.04 and 1.20, preferably between 1.05 and 1.15, particularly preferably between 1.06 and 1.10.

After a residence time of 5 to 20 min in a settling tank, optionally with forced circulation, under the same pressure and at the same temperature as in the last flash/evaporator stage, the oligocarbonate produced in this way is supplied to a disc reactor or basket reactor and condensed further at 250 to 310° C., preferably 250 to 290° C., particularly preferably 250 to 280° C., under pressures of 1 to 15 mbar, preferably 2 to 10 mbar, for residence times of 30 to 90 min, preferably 30 to 60 min. The product reaches a relative viscosity of 1.12 to 1.28, preferably 1.13 to 1.26, particularly preferably 1.13 to 1.24.

The melt leaving this reactor is adjusted to the desired final viscosity or final molecular weight in another disc or basket reactor. The temperatures are 270 to 330° C., preferably 280 to 320° C., particularly preferably 280 to 310° C., the pressure 0.01 to 3 mbar, preferably 0.2 to 2 mbar, with residence times of 60 to 180 min, preferably 75 to 150 min. The relative viscosities are adjusted to the level required for the intended application and are 1.18 to 1.40, preferably 1.18 to 1.36, particularly preferably 1.18 to 1.34.

The function of the two basket reactors may also be combined in one basket reactor.

The vapours from all process stages are immediately drawn off, collected and processed. This processing is generally carried out by distillation in order to obtain high purities in the recovered substances. This may be performed for example in accordance with German patent application no. 10 100 404 (=U.S. Pat. No. 6,703,473 incorporated herein by reference). From an economic and ecological perspective, it is self-evident that the monohydroxyaryl compound that is eliminated should be recovered and isolated in its purest form. The monohydroxyaryl compound may be used directly for the production of a dihydroxyaryl compound or a diaryl carbonate.

The disc or basket reactors are characterised in that they provide a very large, constantly renewing surface at the vacuum with high residence times. The geometry of the disc or basket reactors is designed according to the melt viscosities of the products. Reactors such as those described in DE 44 47 422 C2 and EP A 1 253 163 or twin-screw reactors such as those described in WO A 99/28 370 are suitable (corresponding respectively to U.S. Pat. Nos. 5,779,986; 6,630,563 and 6,329,495 all incorporated herein by reference), for example.

The oligocarbonates, even those having a very low molecular weight, and the finished polycarbonates are generally conveyed by means of gear pumps, screws of various designs or specially designed positive-displacement pumps.

Particularly suitable materials for the production of the equipment, reactors, pipes, pumps and fittings are stainless steels of type CrNi (Mo) 18/10, such as e.g. 1.4571 or 1.4541 (Stahlschlüssel 2001, published by Stahlschlüssel Wegst GmbH, Th-Heuss-Stralβe 36, D-71672 Marbach) and Ni-based alloys of type C, such as e.g. 2.4605 or 2.4610 (Stahlschlüssel 2001, published by Stahlschlüssel Wegst GmbH, Th-Heuss-Straβe 36, D-71672 Marbach). Stainless steels are used up to process temperatures of around 290° C. and Ni-based alloys at process temperatures above around 290° C.

The polycarbonate may however also be produced by the interfacial polycondensation process, for example. This process for polycarbonate synthesis is variously described in the literature, for example inter alia in Schnell, “Chemistry and Physics of Polycarbonates”, Polymer Reviews, Volume 9, Interscience Publishers, New York, London, Sydney 1964, p. 33-70; D. C. Prevorsek, B. T. Debona and Y. Kesten, Corporate Research Center, Allied Chemical Corporation, Morristown, N.J. 07960: “Synthesis of Poly(ester Carbonate) Copolymers” in Journal of Polymer Science, Polymer Chemistry Edition, Vol. 18, (1980)”; p. 75-90; D. Freitag, U. Grigo, P. R. Müller, N. Nouvertne', BAYER AG, “Polycarbonates” in Encyclopedia of Polymer Science and Engineering, Volume 11, Second Edition, 1988, p. 651-692 and finally Drs. U. Grigo, K. Kircher and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, p. 118-145, and in EP-A 0 517 044, for example, and many other patent applications.

According to this process the phosgenation of a disodium salt of a bisphenol (or a mixture of various bisphenols) placed in an aqueous alkaline solution (or suspension) takes place in the presence of an inert organic solvent or solvent blend, which forms a second phase. The oligocarbonates formed, which are mainly present in the organic phase, are condensed with the aid of suitable catalysts to form high-molecular-weight polycarbonates dissolved in the organic phase. Finally the organic phase is separated off and the polycarbonate isolated from it by means of various processing steps.

In this process an aqueous phase consisting of NaOH, one or more bisphenols and water is used, wherein the concentration of this aqueous solution with regard to the total amount of bisphenols, calculated not as sodium salt but as free bisphenol, may vary between 1 and 30 wt. %, preferably between 3 and 25 wt. %, particularly preferably between 3 and 8 wt. %, for polycarbonates having an Mw of >45,000, and between 12 and 22 wt. % for polycarbonates having an Mw of <45,000. At higher concentrations it may be necessary to control the temperature of the solutions. The sodium hydroxide used to dissolve the bisphenols may be used in solid form or as aqueous sodium hydroxide solution. The concentration of sodium hydroxide solution is governed by the target concentration of the bisphenolate solution to be produced, but is generally between 5 and 25 wt. %, preferably between 5 and 10 wt. %, or a more concentrated solution is chosen and is then diluted with water. In the process with subsequent dilution, sodium hydroxide solutions having concentrations of between 15 and 75 wt. %, preferably between 25 and 55 wt. %, optionally with temperature control, are used. The alkali content per mol of bisphenol is very much dependent on the structure of the bisphenol, but is generally in the range between 0.25 mol alkali/mol bisphenol and 5.00 mol alkali/mol bisphenol, preferably 1.5-2.5 mol alkali/mol bisphenol and, in the case where bisphenol A is used as the only bisphenol, 1.85-2.15 mol alkali. If more than one bisphenol is used, they may be dissolved together. It may however be advantageous to dissolve the bisphenols separately in the optimum alkaline phase and to meter in the solutions separately or to feed them into the reaction together. It may also be advantageous to dissolve the bisphenol(s) not in sodium hydroxide solution but in dilute bisphenolate solution containing additional alkali. The dissolution processes may start from solid bisphenol, usually in the form of flakes or pellets, or from molten bisphenol. The sodium hydroxide or sodium hydroxide solution used may be produced by the mercury electrode process or by the so-called membrane process. Both processes have long been used and are familiar to the person skilled in the art. Sodium hydroxide solution produced by the membrane process is preferably used.

The aqueous phase prepared in this way is phosgenated together with an organic phase consisting of solvents for polycarbonate which are inert to the reactants and form a second phase.

The optional metering of bisphenol after or during the introduction of phosgene may be performed for as long as phosgene or its direct secondary products, chloroformic acid esters, are present in the reaction solution.

The synthesis of polycarbonates from bisphenols and phosgene in an alkaline medium is an exothermic reaction and is performed in a temperature range of −5° C. to 100° C., preferably 15° C. to 80° C., most particularly preferably 25 to 65° C., wherein it may optionally be necessary to work under excess pressure, depending on the solvent or solvent blend.

Suitable diphenols for the production of the polycarbonates for use according to the invention are, for example, hydroquinone, resorcinol, dihydroxydiphenyl, bis(hydroxyphenyl) alkanes, bis(hydroxyphenyl) cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl) diisopropyl benzenes, and alkylated, ring-alkylated and ring-halogenated compounds thereof.

Preferred diphenols are 4,4′-dihydroxydiphenyl, 2,2-bis-(4-hydroxyphenyl)-1-phenyl propane, 1,1-bis-(4-hydroxyphenyl) phenyl ethane, 2,2-bis-(4-hydroxyphenyl) propane, 2,4-bis-(4-hydroxyphenyl)-2-methyl butane, 1,1-bis-(4-hydroxyphenyl)-m/p-diisopropyl benzene, 2,2-bis-(3-methyl-4-hydroxyphenyl) propane, bis-(3,5-dimethyl-4-hydroxyphenyl) methane, 2,2-bis-(3,5-dimethyl-4-hydroxyphenyl) propane, bis-(3,5-dimethyl-4-hydroxyphenyl) sulfone, 2,4-bis-(3,5-dimethyl-4-hydroxyphenyl)-2-methyl butane, 1,1-bis-(3,5-dimethyl-4hydroxyphenyl)-m/p-diisopropyl benzene, and 1,1-bis-(4-hydroxyphenyl)-3,3,5-trimethyl cyclohexane.

Particularly preferred diphenols are 4,4′-dihydroxydiphenyl, 1,1-bis-(4-hydroxyphenyl) phenyl ethane, 2,2-bis-(4-hydroxyphenyl) propane, 2,2-bis-(3,5-dimethyl-4-hydroxyphenyl) propane, 1,1-bis-(4-hydroxyphenyl) cyclohexane and 1,1-bis-(4-hydroxyphenyl)-3,3,5-trimethyl cyclohexane.

These and other suitable diphenols are described for example in U.S. Pat. Nos. 2,999,835, 3,148,172, 2,991,273, 3,271,367, 4,982,014 and 2,999,846, in German laid-open applications 1 570 703, 2 063 050, 2 036 052, 2 211 956 and 3 832 396, in French patent specification 1 561 518, in the monograph “H. Schnell, Chemistry and Physics of Polycarbonates, Interscience Publishers, New York 1964, p. 28 ff; p. 102 ff”, and in “D. G. Legrand, J. T. Bendler, Handbook of Polycarbonate Science and Technology, Marcel Dekker, New York 2000, p. 72 ff”.

In the case of homopolycarbonates only one diphenol is used, in the case of copolycarbonates several diphenols are used, wherein the bisphenols used, like all other chemicals and auxiliary substances added to the synthesis, may of course be contaminated with impurities originating from their own synthesis, handling and storage, although it is desirable to work with raw materials that are as clean as possible.

The organic phase may also consist of one solvent or mixtures of several solvents. Suitable solvents are chlorinated hydrocarbons (aliphatic and/or aromatic), preferably dichloromethane, trichloroethylene, 1,1,1-trichloroethane, 1,1,2-trichloroethane and chlorobenzene and mixtures thereof. Aromatic hydrocarbons such as benzene, toluene, m/p/o-xylene or aromatic ethers such as anisol may also be used, however, either alone, mixed together or in addition to or mixed with chlorinated hydrocarbons. Another embodiment of the synthesis uses solvents which do not dissolve but only swell polycarbonate. Precipitants for polycarbonate may therefore also be used in combination with solvents. In this case solvents that are soluble in the aqueous phase, such as tetrahydrofuran, 1,3/1,4-dioxan or 1,3-dioxolan, may also be used as solvents if the solvent partner forms the second organic phase.

The two phases forming the reaction mixture are mixed together to accelerate the reaction. This is achieved by supplying energy by shearing, i.e. with pumps or stirrers, or by means of static mixers or by generating turbulent flow by means of nozzles and/or baffles. Combinations of these measures are also used, often repeatedly over a period of time or in a sequence of equipment. Anchor-type, propeller, MIG stirrers, etc., are preferably used as stirrers, as described for example in Ullmann, “Encyclopedia of Industrial Chemistry”, 5^{th} Edition, Vol. B2, p. 251 ff. Rotary pumps, often also multistage pumps, 2 to 9 stages being preferred, are used as pumps. Perforated baffles or alternatively tapered pipe sections, or venturi or lefos nozzles, are used as nozzles and/or baffles.

The phosgene may be introduced in gaseous or liquid form or dissolved in solvent. The excess of phosgene used, relative to the total amount of bisphenols used, is between 3 and 100 mol %, preferably between 5 and 50 mol %. In this case the pH of the aqueous phase may be held in the alkaline range, preferably between 8.5 and 12, during and after phosgene metering, by the one-off or repeated addition of sodium hydroxide solution or by the corresponding addition of bisphenolate solution, whereas after addition of the catalyst it should be between 10 and 14. The temperature during phosgenation is 25 to 85° C., preferably 35 to 65° C., it also being possible to operate under excess pressure, depending on the solvent used.

The phosgene may be metered directly into the described mixture of organic and aqueous phase, or before the phases are mixed together all or part of it may be metered into one of the two phases, which is then mixed with the corresponding other phase. Furthermore, all or part of the phosgene may be metered into a recycled split stream of the synthesis mixture comprising both phases, this split stream preferably being recycled before addition of the catalyst. In another embodiment the aqueous phase described is mixed with the organic phase containing the phosgene and then after a residence time of 1 second to 5 minutes, preferably 3 seconds to 2 minutes, it is added to the aforementioned recycled split stream, or the two phases, the aqueous phase described and the phosgene-containing organic phase, are mixed directly in the aforementioned recycled split stream. In all these embodiments the aforementioned pH ranges must be checked and optionally maintained by the one-off or repeated addition of sodium hydroxide solution or by the corresponding addition of bisphenolate solution. In the same way the temperature range must be maintained by optionally cooling or diluting the reaction mixture.

The polycarbonate synthesis may be performed continuously or batchwise. The reaction may therefore be performed in stirred-tank reactors, tubular-flow reactors, forced-circulation reactors or series of stirred-tank reactors or in combinations thereof, wherein the aforementioned mixing devices are used to ensure that if possible the aqueous and organic phase do not separate until the reaction of the synthesis mixture has been completed, i.e. it no longer contains any saponifiable chlorine from phosgene or chloroformic acid esters.

The monofunctional chain terminators that are needed to adjust the molecular weight, such as phenol or alkyl phenols, in particular phenol, p-tert-butyl phenol, isooctyl phenol, cumyl phenol, chloroformic acid esters thereof or acid chlorides of monocarboxylic acids or mixtures of these chain terminators, are either supplied to the reaction with the bisphenolate or bisphenolates or are added at any point in the synthesis, provided that phosgene or chloroformic acid end groups are still present in the reaction mixture or, in the case of acid chlorides and chloroformic acid esters as chain terminators, provided that there are sufficient phenolic end groups available in the polymer being formed. The chain terminator(s) is/are preferably added after phosgenation, however, in a place or at a time when there is no more phosgene left but before the catalyst has been introduced, or they are added before the catalyst, together with the catalyst or in parallel with it.

Any branching agents or mixtures of branching agents to be used are added to the synthesis in the same way, but conventionally before the chain terminators. Trisphenols, quaternary phenols or acid chlorides of tricarboxylic or tetracarboxylic acids are conventionally used, or mixtures of polyphenols or acid chlorides.

Some of the compounds having three or more phenolic hydroxyl groups that may be used are, for example
phloroglucinol
4,6-dimethyl-2,4,6-tri-(4-hydroxyphenyl) heptene-2,
4,6-dimethyl-2,4,6-tri-(4-hydroxyphenyl) heptane,
1,3,5-tri-(4-hydroxyphenyl) benzene,
1,1,1-tri-(4-hydroxyphenyl) ethane,
tri-(4-hydroxyphenyl) phenyl methane,
2,2-bis-(4,4-bis-(4-hydroxyphenyl) cyclohexyl] propane,
2,4-bis-(4-hydroxyphenyl isopropyl) phenol,
tetra-(4-hydroxyphenyl) methane.

Some of the other trifunctional compounds are 2,4-dihydroxybenzoic acid, trimesic acid, cyanuric chloride and 3,3-bis-(3-methyl-4-hydroxyphenyl)-2-oxo-2,3-dihydroindole.

Preferred branching agents are 3,3-bis-(3-methyl-4-hydroxyphenyl)-2-oxo-2,3-dihydroindole and 1,1,1-tris-(4-hydroxyphenyl) ethane.

The catalysts used in the interfacial polycondensation synthesis are tertiary amines, in particular triethylamine, tributylamine, trioctylamine, N-ethyl piperidine, N-methyl piperidine, N-i/n-propyl piperidine; quaternary ammonium salts such as tetrabutyl ammonium/tributyl benzyl ammonium/tetraethyl ammonium hydroxide/chloride/bromide/hydrogen sulfate/tetrafluoroborate; and the phosphonium compounds corresponding to the ammonium compounds. Ammonium and phosphonium compounds in this context are referred to together as onium compounds.

As typical interfacial polycondensation catalysts, these compounds are described in the literature, commercially available and familiar to the person skilled in the art. The catalysts may be added to the synthesis alone, in a mixture, at the same time or one after another, optionally also before phosgenation; however, additions after phosgene introduction are preferred unless an onium compound or mixtures of onium compounds are used as catalysts, in which case addition before phosgene introduction is preferred.

The catalyst or catalysts may be added in bulk, in an inert solvent, preferably that used for polycarbonate synthesis, or as an aqueous solution, in the case of tertiary amines as their ammonium salts with acids, preferably mineral acids, in particular hydrochloric acid. If more than one catalyst is used or if partial quantities of the total amount of catalyst are added, various metering methods at various places or at various times may naturally also be used.

The total amount of catalysts used is between 0.001 and 10 mol % relative to mols of bisphenols used, preferably 0.01 to 8 mol %, and particularly preferably 0.05 to 5 mol %.

After introduction of the phosgene it may be advantageous to mix together the organic phase and the aqueous phase for a time, before branching agents, provided that these are not added together with the bisphenolate, chain terminators and catalysts are optionally added. Such a stirring period may be advantageous after each addition. If used, these stirring periods may be between 10 seconds and 60 minutes, preferably between 30 seconds and 40 minutes, particularly preferably between 1 minute and 15 minutes.

The exhausted, at least two-phase, reaction mixture containing at most traces, preferably <2 ppm, of chloroformic acid esters, may be settled out for phase separation. All or part of the aqueous alkaline phase is possibly returned to the polycarbonate synthesis as the aqueous phase or is sent for waste water processing, where solvent and catalyst components are separated off and recycled. In another processing variant, after separating off the organic impurities, in particular solvents and polymer residues, and optionally after establishing a particular pH, e.g. by the addition of sodium hydroxide solution, the salt is separated off and may be sent for chlor-alkali electrolysis, for example, whilst the aqueous phase is optionally returned to the synthesis.

The organic phase containing the polymer must now be freed from all contaminants of an alkaline, ionic or catalytic nature. Even after one or more settling processes, optionally supported by passages through settling tanks, stirred-tank reactors, coalescers or separators or combinations of these measures—wherein water may optionally be added to some or all of the separating stages, optionally using active or passive mixing devices—it still contains amounts of the aqueous alkaline phase in fine droplets and the catalyst, generally a tertiary amine.

After this coarse separation of the alkaline, aqueous phase, the organic phase is washed once or more with dilute acids, mineral, carboxylic, hydroxycarboxylic and/or sulfonic acids. Aqueous mineral acids, in particular hydrochloric acid, phosphorous acid and phosphoric acid or mixtures of these acids, are preferred. The concentrations of these acids should be in the range from 0.001 to 50 wt. %, preferably 0.01 to 5 wt. %.

The organic phase is also repeatedly washed with demineralised or distilled water. The separation of the organic phase, optionally dispersed with parts of the aqueous phase, after the individual washing stages is achieved with settling tanks, stirred-tank reactors, coalescers or separators or combinations of these measures, wherein the washing water may be introduced between the washing stages, optionally using active or passive mixing devices.

Acids, preferably dissolved in the solvent used for the polymer solution, may optionally be added between these washing stages or after washing. Hydrogen chloride gas and phosphoric acid or phosphorous acid, which may optionally also be used as mixtures, are preferably used here.

After the final separation process, the purified polymer solution obtained in this way should contain no more than 5 wt. %, preferably less than 1 wt. %, most particularly preferably less than 0.5 wt. % of water.

The polymer may be isolated from the solution by evaporating the solvent by application of heat, vacuum or a heated carrier gas. Other isolation methods are crystallisation and precipitation.

If the concentration of the polymer solution and possibly also the isolation of the polymer are achieved by removing the solvent by distillation, optionally by superheating and expansion, the term “flash process” is used, see also “Thermische Trennverfahren”, VCH Verlagsanstalt 1988, p. 114; if instead a heated carrier gas is sprayed together with the solution to be evaporated, the term used is “spray evaporation/spray drying”, as described by way of example in Vauck, “Grundoperationen chemischer Verfahrenstechnik”, Deutscher Verlag für Grundstoffindustrie 2000, 11^{th} Edition, p. 690. All of these processes are described in the patent literature and in textbooks and are familiar to the person skilled in the art.

If the solvent is removed by application of heat (distillation) or by the industrially more effective flash process, highly concentrated polymer melts are obtained. In the known flash process polymer solutions are repeatedly heated under a slight excess pressure to temperatures above the boiling point under normal pressure, and these superheated solutions relative to normal pressure are then expanded in a vessel under reduced pressure, e.g. normal pressure. It may be advantageous here to ensure that the concentration stages, or in other words the temperature stages of the superheating process, do not become too large, but instead to choose a two-stage to four-stage process.

The residual solvent may be removed from the highly concentrated polymer melts obtained in this way either directly from the melt with evaporation extruders (BE-A 866 991, EP-A 0 411 510, U.S. Pat. No. 4,980,105, DE-A 33 32 065), film evaporators (EP-A 0 267 025), falling-film evaporators, strand evaporators or by friction compacting (EP-A 0 460 450), optionally also with addition of a separating agent such as nitrogen or carbon dioxide, or using a vacuum (EP-A 003 996, EP-A 0 256 003, U.S. Pat. No. 4,423,207), alternatively also by subsequent crystallisation (DE-A 3 429 960) and by baking out the residual solvent in the solid phase (U.S. Pat. No. 3,986,269, DE-A 2 053 876).

Pellets are preferably obtained by direct spinning of the melt and subsequent pelletisation or by using melt extruders from which the melt is spun in air or under liquid, usually water. If extruders are used, additives may be added to the melt ahead of this extruder, optionally using static mixers or by means of ancillary extruders in the extruder.

In the case of spraying, the polymer solution is either sprayed into a vessel under reduced pressure, optionally after being heated, or is sprayed by means of a nozzle with a heated carrier gas, e.g. nitrogen, argon or steam, into a vessel under normal pressure. In both cases, depending on the concentration of the polymer solution, polymer powder (diluted) or flakes (concentrated) are obtained, from which the final residues of solvent must optionally be removed as described above. Pellets may then be obtained by means of a compounding extruder and subsequent spinning. In this case too additives, as described above, may be added in the peripheral units or in the extruder itself. Due to the low apparent density of the powders and flakes, a compacting step often has to be used for the polymer powder before extrusion.

By the addition of a precipitating agent for polycarbonate, the polymer may be precipitated out of the washed and optionally further concentrated polycarbonate solution in a largely crystalline form. Here it is advantageous to begin by adding just a small amount of precipitating agent and optionally also to allow waiting times between additions of batches of precipitating agent. It may moreover be advantageous to use various precipitating agents. Hydrocarbons, in particular heptane, i-octane-cyclohexane, and alcohols such as methanol, ethanol, i-propanol may be used here as precipitating agents, for example.

The precipitation process generally involves the slow addition of the polymer solution to a precipitating agent; in this case alcohols such as methanol, ethanol, i-propanol are generally used, but cyclohexane or ketones such as acetone may also be used as precipitating agent.

The materials thus obtained are processed into pellets as described for the spray evaporation process and optionally supplemented with additives.

According to other processes, precipitation and crystallization products or amorphously solidified products in fine-particle form are crystallised by passing over vapours of one or more precipitating agents for polycarbonate with simultaneous heating below the glass transition temperature and then condensed to obtain higher molecular weights. In the case of oligomers, optionally having different end groups (phenolic and chain terminator end groups), this process is described as solid-phase condensation.

Heat Stabilizers:

The heat stabilizers of the invention according to formulae (I) to (XI) are preferably added once the desired molecular weight for the polycarbonate has been reached. Static mixers or other mixers leading to a homogeneous incorporation, such as extruders for example, are suitable for mixing in the heat stabilizer effectively. In the latter case the heat stabilizer is added to the main polymer stream by means of an ancillary extruder for the polymer melt, possibly together with other substances such as release agents, for example.

The heat stabilizers according to the invention may be added to the polymer melt alone or in any mixture with one another or in several different mixtures. Mixtures of the heat stabilizers according to the invention with free sulfonic acid derivatives, such as e.g. benzene or toluene sulfonic acid, may also be added.

The heat stabilizers preferably have melting points above 30° C., preferably above 40° C. and particularly preferably above 50° C. and boiling points at 1 mbar above 150° C., preferably above 200° C. and particularly preferably above 230° C.

The esters of organic sulfur-containing acids according to the invention may be used in quantities of less than 100 ppm relative to the polycarbonate, preferably less than 50 ppm relative to the polycarbonate, particularly preferably less than 30 ppm and most particularly preferably less than 15 ppm.

At least 0.5 ppm of heat stabilizers or mixtures thereof are preferably used, particularly preferably 1 ppm, most particularly preferably 1.5 ppm. In particular, the heat stabilizers are used in quantities of 2 to 10 ppm relative to the polycarbonate.

They may optionally also be added mixed together with free acids, such as e.g. ortho-phosphoric acid or other additives that are suitable as stabilizers, such as e.g. benzene or toluene sulfonic acids. The amount of free acids or other stabilizers (relative to polycarbonate) is up to 20 ppm, preferably up to 10 ppm, in particular 0 to 5 ppm.

There are no limits on the form of addition of the esters of organic sulfur-containing acids according to the invention. The esters of organic sulfur-containing acids according to the invention or mixtures thereof may be added to the polymer melt as a solid, in other words as a powder, in solution or as a melt. Another type of addition is the use of a masterbatch (preferably with polycarbonate), which may also contain other additives, such as other stabilizers or release agents for example.

The esters of organic sulfur-containing acids according to the invention are preferably added in liquid form. Since the amounts to be added are very low, solutions of the esters according to the invention are preferably used.

Suitable solvents are types that do not disrupt the process, are chemically inert and evaporate rapidly.

Examples of suitable solvents include all organic solvents having a boiling point under normal pressure of 30 to 300° C., preferably 30 to 250° C. and particularly preferably 30 to 200° C., and water—including water of crystallization. Such compounds that are present in the various processes are preferably chosen. Any residual amounts that may remain, depending on the range of requirements for the product to be produced, do not reduce the quality.

In addition to water, solvents are alkanes, cycloalkanes and aromatics, which may also be substituted. The substituents may be aliphatic, cycloaliphatic or aromatic radicals in various combinations and halogens or a hydroxyl group. Heteroatoms, such as oxygen for example, may also be binding links between aliphatic, cycloaliphatic or aromatic radicals, wherein the radicals may be the same or different. Other solvents may also be ketones and esters of organic acids and cyclic carbonates. The heat stabilizer may also be dissolved in glycerol monostearate and added in that form.

In addition to water, examples are n-pentane, n-hexane, n-heptane and isomers thereof, chlorobenzene, methanol, ethanol, propanol, butanol and isomers thereof, phenol, o-, m- and p-cresol, acetone, diethyl ether, dimethyl ketone, polyethylene glycols, polypropylene glycols, ethyl acetates, ethylene carbonate and propylene carbonate.

Water, phenol, propylene carbonate, ethylene carbonate and toluene are preferably suitable for the polycarbonate process.

Particularly preferably suitable are water, phenol and propylene carbonate.

Free sulfonic acids and in some cases also esterified sulfonic acids and also alcohols are produced as degradation products of the heat stabilizers according to the invention having formulae (I) to (XI).

The polycarbonate obtained may also compounded with known conventional additives for their known function in the context of polycarbonate molding compositions after addition of the inhibitors according to the invention in order to modify its properties. These additives and serve to extend the useful life (e.g. hydrolysis or degradation stabilizers), to improve color stability (e.g. heat and UV stabilizers), to facilitate processing (e.g. release agents, flow control agents), to improve performance characteristics (e.g. antistatics), to improve flame proofing, to influence the appearance (e.g. organic dyes, pigments) or to adapt the polymer properties to specific stresses (impact modifiers, finely divided minerals, fibers, silica flour, glass and carbon fibers). All may be combined in any way in order to adjust and achieve the desired properties. Such additives and loading materials are described for example in “Plastics Additives”, R. Gächter and H. Müller, Hanser Publishers 1983.

These additives and loading materials may be added to the polymer melt alone or in any mixture or in several different mixtures and either directly during isolation of the polymer or after melting of pellets in a so-called compounding stage.

The additives and loading materials or mixtures thereof may be added to the polymer melt as a solid, in other words as a powder, or as a melt. Another type of addition is the use of masterbatches or mixtures of masterbatches of the additives or mixtures of additives.

These substances are preferably added to the final polycarbonate in conventional units but, depending on requirements, they may also be added at another stage in the polycarbonate production process.

Suitable additives are described for example in Additives for Plastics Handbook, John Murphy, Elsevier, Oxford 1999 or Plastics Additives Handbook, Hans Zweifel, Hanser, Munich 2001.

Examples of other applications that may be cited, without however restricting the subject of the present invention, are:
1. Safety glass, which is known to be needed in many areas of buildings, vehicles and aircraft, and as visors for helmets.
2. Films.
3. Blow moldings (see also U.S. Pat. No. 2,964,794), for example 1 to 5 gallon water bottles.
4. Translucent sheets, such as solid sheets or in particular twin-wall sheets, for example for covering buildings such as stations, greenhouses and lighting installations.
5. Optical data storage media, such as audio CDs, CD-R(W)s, DCDs, DVD-R(W)s, minidiscs and subsequent developments thereof.
6. Traffic light housings or road signs.
7. Foams with an open or closed and optionally printable surface.
8. Threads and wires (see also DE-A 11 37 167).
9. Lighting applications, optionally using glass fibers for applications in the translucent sector.
10. Translucent formulations containing barium sulfate and/or titanium dioxide and/or zirconium oxide or organic polymeric acrylate rubbers (EP-A 0 634 445, EP-A 0 269 324) for producing translucent and light-scattering molded parts.
11. Precision injection moldings, such as holders, e.g. lens holders; polycarbonates having a content of glass fibers and optionally additionally containing 1-10 wt. % of molybdenum disulfide (relative to the total molding composition) are optionally used for this purpose.
12. Optical device components, in particular lenses for photographic and film cameras (DE-A 27 01 173).
13. Light carriers, in particular optical cables (EP-A 0 089 801) and lighting strips.
14. Electrical insulating materials for electrical cables and for connector shells and plug-in connectors, and for capacitors.
15. Mobile telephone cases.
16. Network interface devices.
17. Supports for organic photoconductors.
18. Lamps, headlamps, diffusers or internal lenses.
19. Medical applications such as oxygenators, dialysis machines.
20. Food applications, such as bottles, crockery and chocolate molds.
21. Applications in the automotive sector, such as glazing or in the form of blends with ABS as bumpers.
22. Sports articles such as slalom poles, ski boot clips.
23. Domestic items, such as kitchen sinks, washbasins, letterboxes.
24. Enclosures, such as electrical distribution cabinets.
25. Housings for electrical appliances such as toothbrushes, hairdryers, coffee makers, machine tools, such as drilling machines, milling machines, planing machines and saws.
26. Washing machine portholes.
27. Protective goggles, sunglasses, optical correction spectacles and lenses.
28. Lamp covers.
29. Packaging films.
30. Chip boxes, chip carriers, boxes for Si wafers.
31. Other applications such as stable doors or animal cages.

The examples below are intended to illustrate the present invention without restricting it, however:

### EXAMPLES

The relative solution viscosity is determined in dichloromethane at a concentration of 5 g/l at 25° C.

The content of phenolic OH is obtained by IR measurement. To this end a differential measurement of a solution comprising 2 g of polymer in 50 ml dichloromethane is measured against pure dichloromethane and the absorbance difference at 3582 cm⁻¹ is determined.

Analytical instructions for the determination of residual monomers:

The sample is dissolved in dichloromethane and reprecipitated in acetone/methanol. The precipitated polymer is separated off and the filtrate is concentrated to small volume. The residual monomers are quantified by reverse phase chromatography in the solvent gradient 0.04% phosphoric acid-acetonitrile. Detection is by UV.

Bisphenol (BPA), phenol and diphenyl carbonate (DPC) are determined in this way.

The term GMS refers to a mixture of glycerol monopalmitate and glycerol monostearate.

The total GMS content consists of the free GMS (GMS_{free}), the GMS carbonate (GMS-CO₃) and the incorporated GMS. The latter is calculated by subtraction.

Part of the sample is hydrolyzed in the alkaline state at around 80° C. and then adjusted to a pH of around 1 with hydrochloric acid. This solution is extracted with tert-butyl methyl ether and the extract is dried. Derivatisation is followed by gas-chromatographic analysis on a capillary column in conjunction with a flame ionisation detector. Quantitative analysis is carried out using an internal standard and gives the total content of GMS.

Another part of the sample is dissolved in dichloromethane and derivatised. After gas-chromatographic separation on a capillary column and detection with a flame ionisation detector (FID), quantification is carried out using an internal standard. The contents of free GMS and GMS carbonate are obtained.

Quantification of glycerol monostearate (GMS) and glycerol monostearate carbonate (GMS carbonate) in polycarbonate by GC FID:

Approx. 0.5 g sample are dissolved in 5 ml CH₂Cl₂ and an internal standard (e.g. n-alkane) is added. Approx. 5 ml tert-butyl methyl ether (MTBE) are added to this solution in order to precipitate out the polymer. The suspension is then shaken and then centrifuged. A defined amount (3 ml) of the supernatant solution is pipetted off and evaporated to dryness under a nitrogen atmosphere. The residue is silylated with MSTFA solution (N-methyl-N-(trimethylsilyl) trifluoroacetamide). The filtered solution is chromatographed by gas chromatography (GC) (e.g. HP 6890). Detection is by flame ionisation detector (FID).

Charge Materials:

Polycarbonate B:

| | | |
|---|---|---|
| relative solution viscosity | 1.201 | |
| content of phenolic OH | 240 | ppm |
| DPC | 80 | ppm |
| BPA | 10 | ppm |
| phenol | 65 | ppm |
| GMS_{free} | 288 | ppm |
| GMS-CO₃ | <10 | ppm |

Heat Stabilizer A:

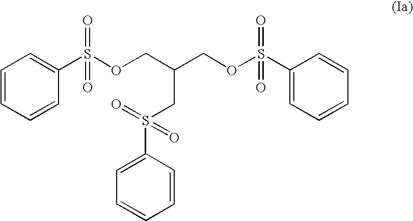

The influence of the heat stabilizers according to the invention on the improvement of the thermal stability of a polycarbonate is examined by reference to the long-term thermal stability of the polycarbonate.

### Example A

Synthesis of Heat Stabilizer A:

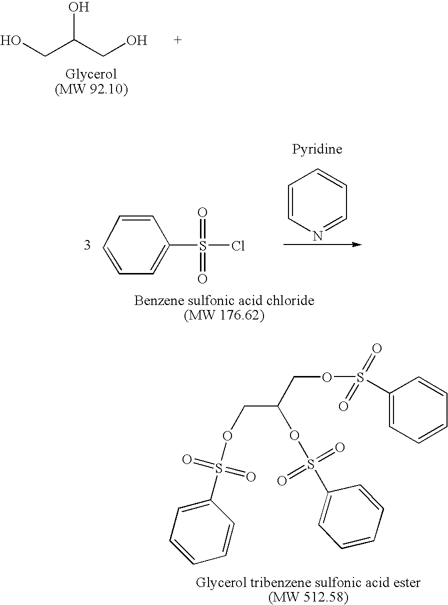

552.6 g (6.0 mol) glycerol supplied by KMF and 4746 g (60 mol) pyridine supplied by Aldrich are placed under nitrogen and dissolved homogeneously. 3196.8 g (18.1 mol) benzene sulfonic acid chloride are added very slowly dropwise, wherein a temperature of 30 to 35° C. should not be exceeded. The mixture is then stirred for 1 hour at 40° C.

Preparation:

The batch is very slowly discharged into a mixture of 3 litres of distilled water, approximately 4 kg of ice and 3 litres of dichloromethane with vigorous stirring. A temperature of 35° C. should not be exceeded in this process.

The organic phase is then precipitated into approx. 10 litres of methanol, extracted and washed with methanol until detection by film chromatography indicates a clean product.

It is then dried to constant mass in a vacuum drying oven at 60° C.

Yield: 970 g (31.54% of theoretical) of white powder Analysis: Melting point m.p. 81-83° C. ¹H-NMR (400 MHz, TMS, CDCl₃) δ=7.8 ppm (m, 6H), 7.7 (m, 3H), 7.55 (m, 6H), 4.75 (m, 1H), 4.1 (d, 4H).

### Example 1

2.5 kg polycarbonate B are mixed homogeneously with 4 ppm of heat stabilizer A (as powder), relative to the polycarbonate, in an extruder (starting material). This mixture is exposed to heat for 10 minutes at 340° C. and 10 minutes at 360° C. and then analyzed chemically (Table 1).

### Comparative Example 1

Same as Example 1, except that 3 ppm of ortho-phosphoric acid are incorporated instead of 4 ppm of heat stabilizer A.

TABLE 1

| | | Starting | | |
|---|---|---|---|---|
| | | material | 340° C. | 360° C. |
| Rel. viscosity | Ex. 1 | 20.1 | 19.6 | 19.4 |
| | Comp. ex. 1 | 20.1 | 19.7 | 19.3 |
| GMS_{free}/ppm | Ex. 1 | 288 | 60 | 69 |
| | Comp. ex. 1 | 288 | <10 | <10 |
| GMS-CO₃/ppm | Ex. 1 | <10 | <10 | <10 |
| | Comp. ex. 1 | <10 | 70 | 30 |
| DPC | Ex. 1 | 80 | 81 | 80 |
| recleavage/ppm | Comp. ex. 1 | 80 | 500 | 500 |

The examples provide evidence of the improved stability of the polycarbonate when exposed to heat in comparison to comparative example 1 with phosphoric acid as stabilizer, as expressed by a higher content of free GMS, a lower content of GMS-CO₃ and a markedly lower rate of reformation to diphenyl carbonate DPC. The content of residual monomers (DPC) may thus be kept to a relatively low level. This is particularly important for optical data storage media applications, since when the polycarbonate is injected, the evaporated monomer component may set as a coating on the injection mold (stamper) (known as blading out), which is undesirable.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

1. A thermoplastic molding composition comprising polycarbonate and an ester of organic sulfur-containing acid.

2. The composition according to claim 1, wherein the ester is at least one compound selected from the group conforming to
a) formula (I) 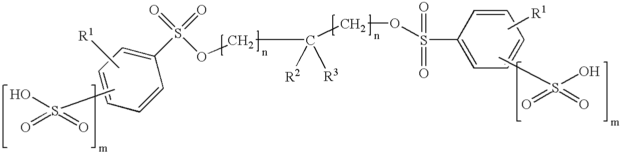
wherein
R¹ independently stands for hydrogen or for unsubstituted or halogen-substituted C₁-C₂₀ alkyl,
R² and R³ mutually independently stand for hydrogen, C₁-C₆ alkyl or C₄-C₃₀ alkyl carboxyl or for the radical 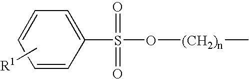
wherein
R¹ has the meaning given above,
m denotes 0 or 1
n stands for a whole number from 0 to 8,
b) formula (II) 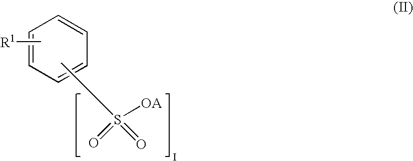
wherein
R¹ has the meaning given above,
A independently stands for hydrogen or for C₁-C₁₂ alkyl,
l stands for 2 or 3,
c) formula (III) 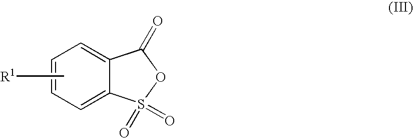
wherein
R¹ has the meaning given above
and
d) formula (IV) 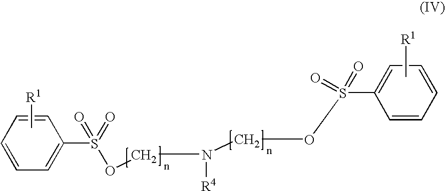
wherein
R¹ and n have the meaning given above, and
R⁴ stands for C₄-C₃₀ alkyl carboxyl, or
for the following radical 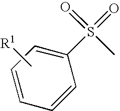
wherein R¹ has the meaning given above,
and
e) formulas (V), (VI), (VIIa), (VIb), (Ib), (IVb) 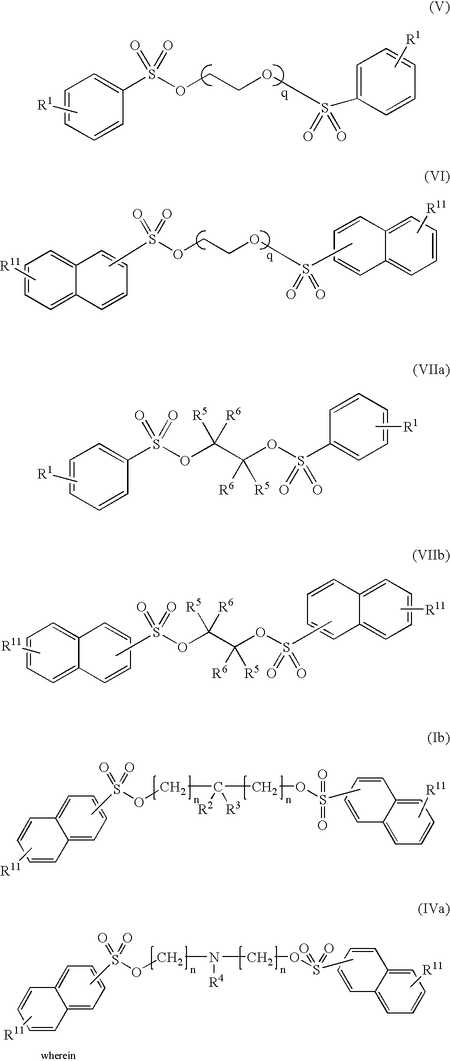
wherein
R¹ and n have the meaning given above, and
q stands for a whole number from 0 to 10,
R⁵ and R⁶ independently stand for hydrogen or for C₁-C₂₀ alkyl, and
R¹¹ independently stands for hydrogen or di-(C₁-C₄) alkyl amino, and
f) formula (VIII) 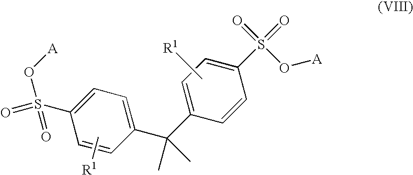
wherein
R¹ and A have the meaning given above and
g) formula (IX) 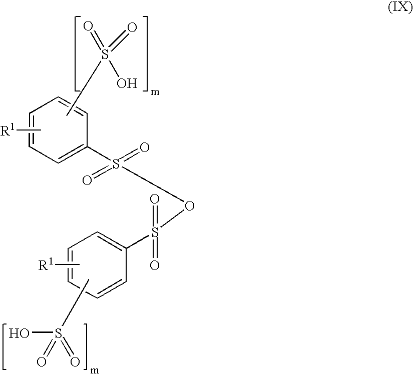
wherein
R¹ and m have the meaning given above and
h) formula (X) 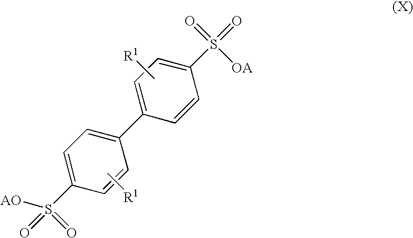
wherein
R¹ and A have the meaning given above and
i) formula (XI) 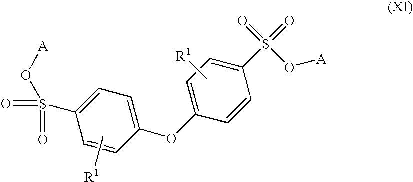
wherein
R¹ and A have the meaning given above.

3. The composition according to claim 1 wherein the ester is present in a positive amount up to 100 ppm relative to the weight of the polycarbonate.

4. The composition according to claim 1 further comprising at least one degradation product of said ester.

5. An extruded article comprising the composition of claim 1.

6. A thermoplastically molded article comprising the composition of claim 1.
